(19) United States
(12) Patent Application Publication
(10) Pub. No.: US 2026/0259397 A1
(43) Pub. Date: Sep. 3, 2026

(54) ZOOM LENS AND IMAGE PICKUP APPARATUS

(71) Applicant: CANON KABUSHIKI KAISHA, Tokyo (JP)

(72) Inventor: Makoto NAKAHARA, Tochigi (JP)

(21) Appl. No.: 19/657,195

(22) Filed: Apr. 24, 2026

Related U.S. Application Data
(63) Continuation of application No. PCT/JP2024/030434, filed on Aug. 27, 2024.

(30) Foreign Application Priority Data
Dec. 6, 2023 (JP) 2023-206098

(51) Int. Cl. G02B 15/14; G02B 15/20

(52) U.S. Cl. CPC G02B 15/1461; G02B 15/20

(57) ABSTRACT

A zoom lens includes lens units that consist of, in order from an object side to an image side, a first lens unit having positive refractive power, a second lens unit, and a rear group including a plurality of lens units. Each distance between adjacent lens units changes during zooming. A lens unit disposed closest to an image plane in the zoom lens has negative refractive power. During zooming from a wide-angle end to a telephoto end, a distance between the first lens unit and the second lens unit increases and a distance between the second lens unit and the rear group increases. Predetermined inequalities are satisfied.

### CROSS-REFERENCE TO RELATED APPLICATIONS

This application is a Continuation of International Patent Application No. PCT/JP2024/030434, filed on Aug. 27, 2024, which claims the benefit of Japanese Patent Application No. 2023-206098, filed on Dec. 6, 2023, both of which are hereby incorporated by reference herein in their entirety.

### BACKGROUND

### Field of the Technology

The present disclosure relates to a zoom lens for imaging (shooting) and an image pickup apparatus.

### Description of the Related Art

Zoom lenses for imaging include so-called positive lead type zoom lenses that satisfy demands for high optical performance and reduced size and weight, in which a lens unit having positive refractive power is disposed closest to an object.

Japanese Patent Application Laid-Open No. 2022-92388 discloses a zoom lens including a first lens unit having positive refractive power and disposed closest to the object, wherein a distance between adjacent lens units changes during zooming.

In general, in order to reduce the size of a zoom lens, it is effective to adopt a telephoto type power arrangement at a telephoto end and to increase positive refractive power on the object side and negative refractive power on the image side. However, when refractive power of each respective lens unit is increased, variations in various aberrations accompanying zooming increase, and it becomes difficult to satisfactorily correct a variety of aberrations with a small number of lenses. Further, in a positive lead type zoom lens, an effective diameter of a lens unit on the object side increases, and therefore a configuration of the lens unit on the object side for reducing weight becomes important. Therefore, in order to reduce the size and weight of a zoom lens, it is important to properly set both refractive power of each lens unit and a configuration of the lens unit on the object side.

### SUMMARY

A zoom lens according to one aspect of the present disclosure may include lens units that consist of, in order from an object side to an image side, a first lens unit having positive refractive power, a second lens unit, and a rear group including a plurality of lens units. Each distance between adjacent lens units changes during zooming. A lens unit disposed closest to an image plane in the zoom lens has negative refractive power. During zooming from a wide-angle end to a telephoto end, a distance between the first lens unit and the second lens unit increases and a distance between the second lens unit and the rear group increases. The following inequalities are satisfied:

$$4.4 \leq D 2 t / D 2 w \leq 15.$$

$$- 2.8 \leq fL 1 / fL 2 \leq 3.$$

where D2w is a distance on an optical axis from a surface closest to an object of the zoom lens to a surface closest to the image plane of the second lens unit at the wide-angle end, D2t is a distance on the optical axis from the surface closest to the object to the surface closest to the image plane of the second lens unit at the telephoto end, fL1 is a focal length of the first lens unit, and fL2 is a focal length of the second lens unit. An image pickup apparatus having the above zoom lens also constitutes another aspect of the present disclosure.

Features of the present disclosure will become apparent from the following description of embodiments with reference to the attached drawings. The following description of embodiments is described by way of example.

### BRIEF DESCRIPTION OF THE DRAWINGS

FIG. 1 is a cross-sectional view of a zoom lens according to Example 1.

FIGS. 2A, 2B, and 2C illustrate aberration diagrams of the zoom lens according to Example 1.

FIG. 3 is a cross-sectional view of a zoom lens according to Example 2.

FIGS. 4A, 4B, and 4C illustrate aberration diagrams of the zoom lens according to Example 2.

FIG. 5 is a cross-sectional view of a zoom lens according to Example 3.

FIGS. 6A, 6B, and 6C illustrate aberration diagrams of the zoom lens according to Example 3.

FIG. 7 is a cross-sectional view of a zoom lens according to Example 4.

FIGS. 8A, 8B, and 8C illustrate aberration diagrams of the zoom lens according to Example 4.

FIG. 9 is a cross-sectional view of a zoom lens according to Example 5.

FIGS. 10A, 10B, and 10C illustrate aberration diagrams of the zoom lens according to Example 5.

FIG. 11 is a cross-sectional view of a zoom lens according to Example 6.

FIGS. 12A, 12B, and 12C illustrate aberration diagrams of the zoom lens according to Example 6.

FIG. 13 is a schematic diagram of an image pickup apparatus including any one of the zoom lenses according to Examples 1 to 6.

### DESCRIPTION OF THE EMBODIMENTS

Referring now to the accompanying drawings, a description will be given of embodiments according to the present disclosure.

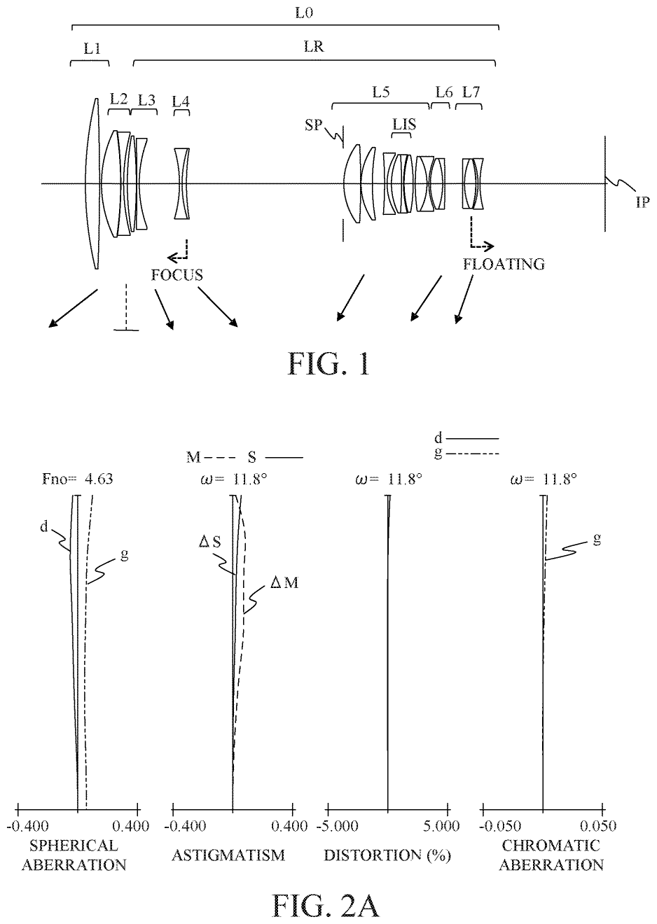

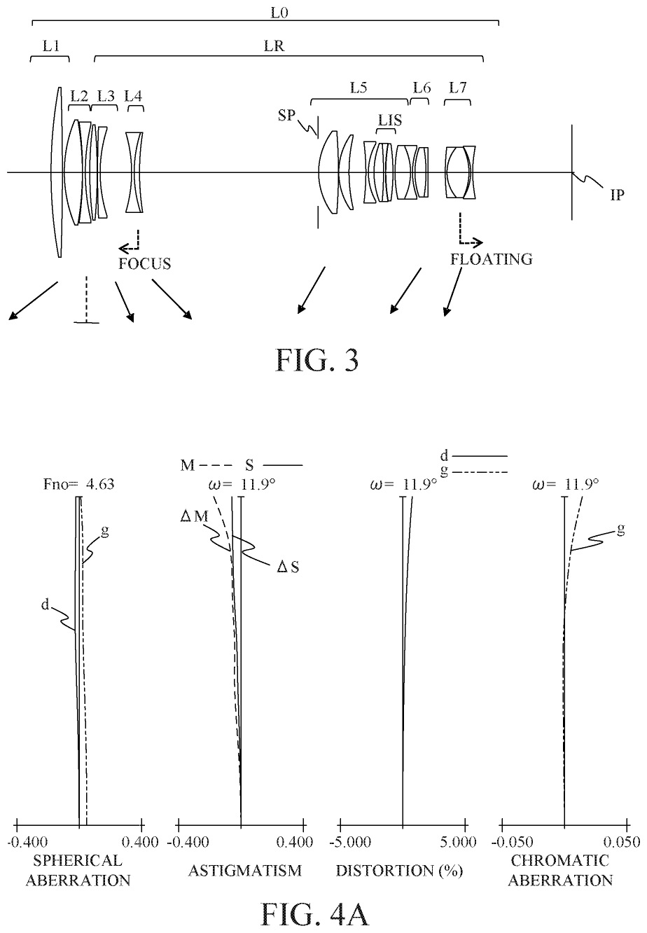

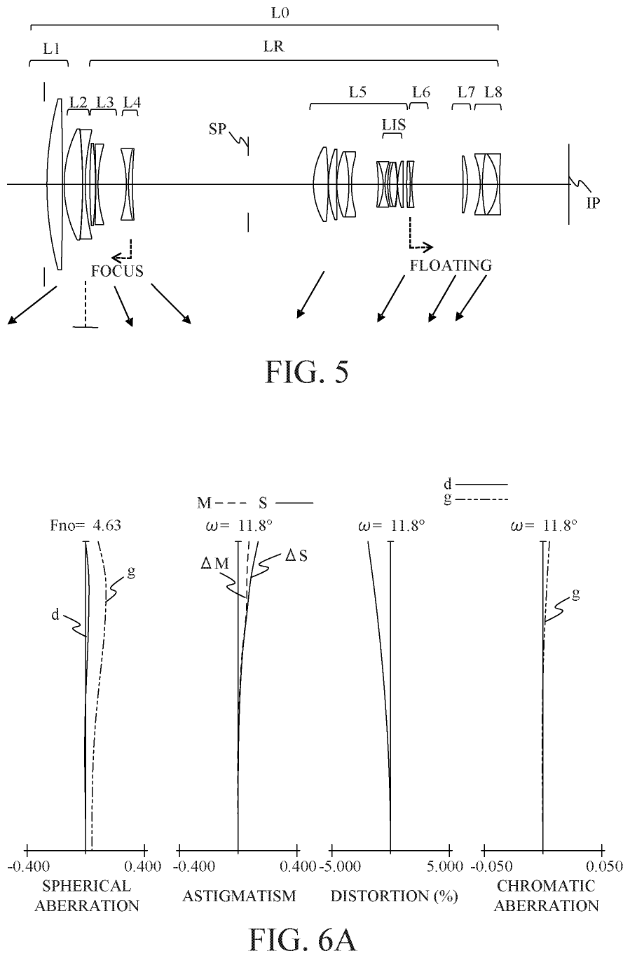

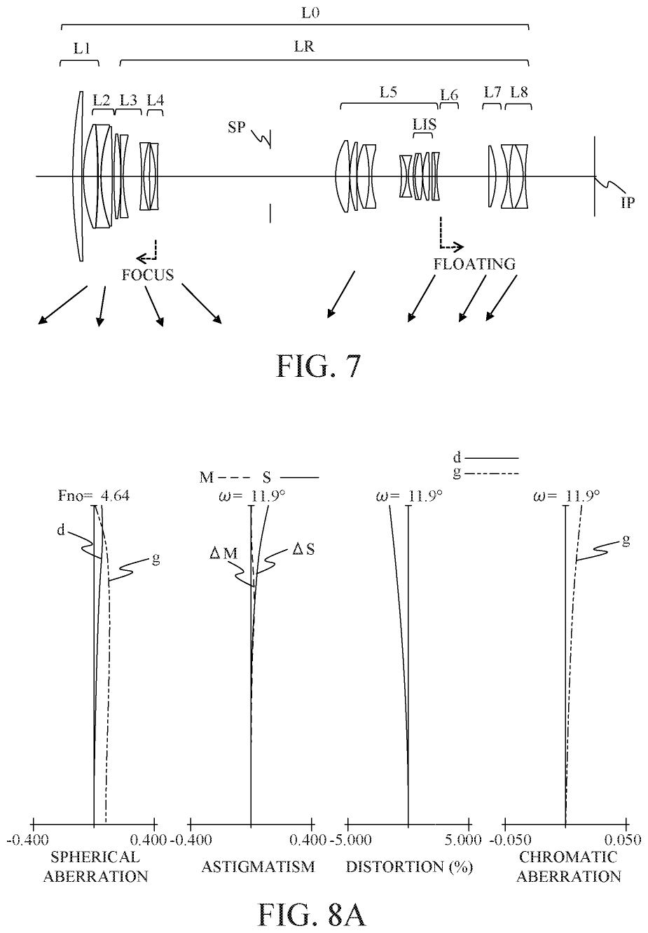

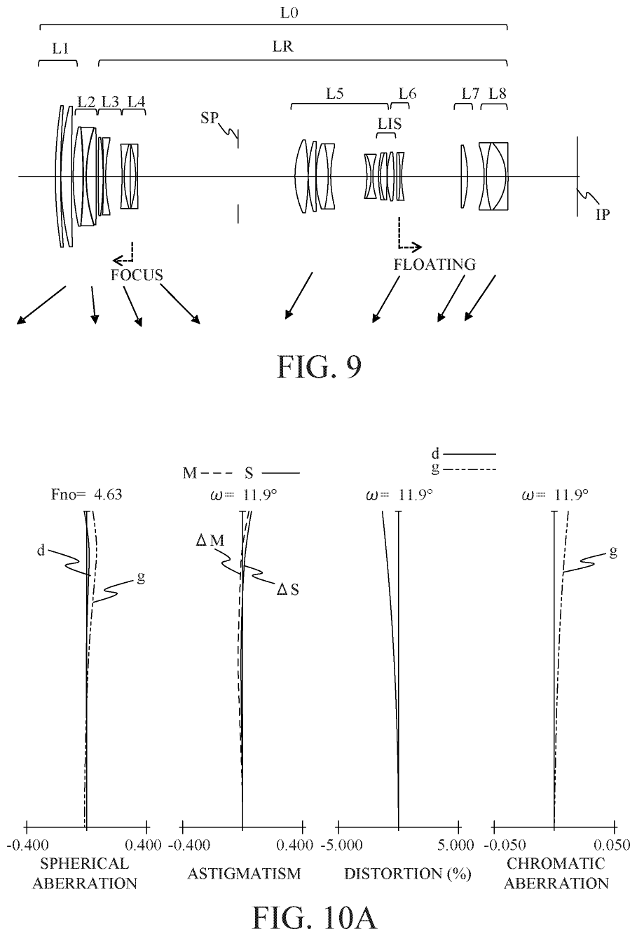

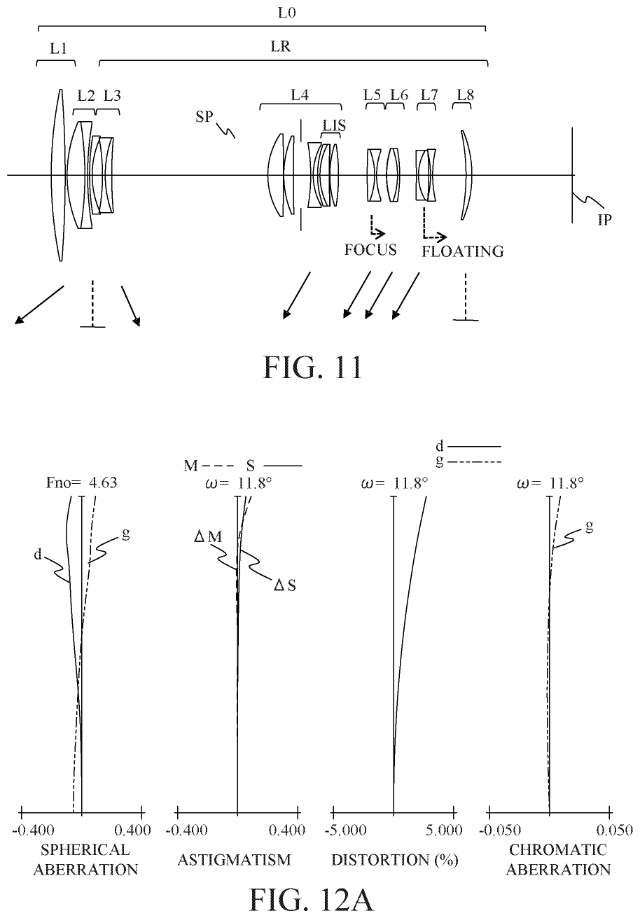

FIGS. 1, 3, 5, 7, 9, and 11 illustrate cross sections of zoom lenses L0 according to Examples 1 to 6 in a state at a wide-angle end in an in-focus state (on an object) at infinity. The zoom lens L0 according to each example is used in optical apparatuses including an image pickup apparatus such as a digital video camera, a digital still camera, a broadcasting camera, a silver-halide film camera, or a surveillance camera, and interchangeable lenses. The zoom lens L0 may also be used in observation optical apparatuses such as telescopes.

In each cross-sectional view, a left side is an object side (front side) and a right side is an image side (rear side). The zoom lens L0 according to each example includes a plurality of lens units each having refractive power. In a zoom lens, a lens unit is a group of one or more lenses that move integrally during magnification variation (zooming) between a wide-angle end and a telephoto end. That is, a distance between adjacent lens units changes during zooming. A lens unit may include an aperture stop (diaphragm). Further, the wide-angle end and the telephoto end indicate zoom states of a maximum angle of view (shortest focal length) and a minimum angle of view (longest focal length), respectively, when lens units that move during zooming are positioned at opposite ends of a mechanically or controllably movable range on an optical axis. Refractive power is a reciprocal of focal length.

In each cross-sectional view, Li represents an i-th lens unit counted from the object side among a plurality of lens units included in the zoom lens L0. LR represents a rear group including all lens units disposed on an image side of (closer to an image plane than) a second lens unit L2. LIS represents an image stabilizing unit having a function (image stabilizing function) for correcting image blur due to camera shake or the like by moving in a direction including a component perpendicular to the optical axis. The image stabilizing unit may be an entire lens unit or a partial unit that forms part of the lens unit. The partial unit is a group of one or more lenses having a constant constituent length (a distance from a lens surface closest to the object to a lens surface closest to the image plane of the partial unit) during zooming.

SP represents an aperture stop. IP represents an image plane. On the image plane IP, an imaging surface (light receiving surface) of a solid-state image sensor (photoelectric conversion element) such as a CCD sensor or a CMOS sensor, or a film surface (photosensitive surface) of a silver-halide film is disposed. An optical element such as a parallel plate having no refractive power or a prism, for example a low-pass filter or an infrared-cut filter, may be disposed between a lens disposed closest to the image plane of the zoom lens L0 and the image plane IP.

In each cross-sectional view, below a lens unit that moves during zooming, a moving locus of the lens unit during zooming from the wide-angle end to the telephoto end is schematically indicated by a solid arrow. Below a focus lens unit that moves during focusing, a moving direction of the lens unit during focusing from an object at infinity to an object at a close distance is indicated by a dashed arrow.

In the zoom lens L0 according to each example, the rear group LR includes a first focus lens unit (Focus) serving as a main focus lens unit and a second focus lens unit (Floating) disposed on an image side thereof and serving as a floating unit. The second focus lens unit moves independently of the first focus lens unit (that is, along a different locus) during focusing.

First, the characteristics common to the zoom lens L0 according to each example will be described. The zoom lens L0 according to each example is a positive lead type zoom lens in which refractive power of the first lens unit L1 is positive. The zoom lens L0 according to each example includes lens units that consist of, in order from the object side to the image side, a first lens unit L1 having positive refractive power, a second lens unit L2, and a rear group LR including a plurality of lens units. The rear group LR consists of all lens units disposed on the image side of the second lens unit L2 (a third lens unit L3 to a seventh lens unit L7 or an eighth lens unit L8).

In the zoom lens L0 according to each example, during zooming from the wide-angle end to the telephoto end, the first lens unit L1 moves, a distance between the first lens unit L1 and the second lens unit L2 increases, and a distance between the second lens unit L2 and the rear group LR increases. As a result, a telephoto-type power arrangement is obtained at the telephoto end, which is beneficial for reducing an overall length of the zoom lens L0.

In general, as a focal length of a zoom lens at the telephoto end increases, chromatic aberration tends to increase, and the size of the first lens unit having positive refractive power tends to increase. This is because, at the telephoto end, an incident height of an on-axis ray increases for lenses disposed closer to the object, and an effective diameter (a radius of a region through which rays contributing to imaging pass) increases. From a viewpoint of chromatic aberration correction, a plurality of positive lenses formed of low-dispersion materials may be disposed on the object. However, from a viewpoint of weight reduction, an effective diameter of lenses disposed on the object side may be reduced and the number of lenses disposed on the object side may be as small as possible. This is because a volume (mass) of a lens is approximately proportional to a cube of the effective diameter.

Accordingly, in the zoom lens L0 according to each example, a distance on the optical axis from a surface closest to the object of the zoom lens L0 to a surface closest to the image plane of the second lens unit L2 and refractive powers of the first lens unit L1 and the second lens unit L2 are properly set. More specifically, the zoom lens L0 according to each example may satisfy the following inequalities (1) and (2):

$$4.4 \leq D 2 t / D 2 w \leq 15. \qquad ( 1 )$$

$$- 2.8 \leq fL 1 / fL 2 \leq 3. \qquad ( 2 )$$

Inequality (1) defines a proper relationship between a distance D2w on the optical axis from a surface closest to the object (frontmost surface) of the zoom lens L0 to a surface closest to the image plane of the second lens unit L2 at the wide-angle end and a distance D2t on the optical axis from the frontmost surface to the surface closest to the image plane of the second lens unit L2 at the telephoto end. By satisfying inequality (1), an overall thickness of the first lens unit L1 and the second lens unit L2 can be reduced at the wide-angle end, and an effective diameter of the second lens unit L2 can be reduced at the telephoto end, thereby facilitating weight reduction of the zoom lens. In a case where the distance D2t becomes excessively small so that D2t/D2w becomes lower than the lower limit of inequality (1), the effective diameter of the second lens unit L2 increases and weight reduction of the zoom lens L0 becomes difficult. In a case where the distance D2t excessively increases so that D2t/D2w becomes higher than the upper limit of inequality (1), the size reduction of the zoom lens L0 at the telephoto end becomes difficult.

Inequality (2) defines a proper relationship between a focal length fL1 of the first lens unit L1 and a focal length fL2 of the second lens unit L2. By satisfying inequality (2), refractive power of the first lens unit L1 becomes stronger, and the correction of chromatic aberration at the telephoto end becomes easier. In a case where the focal length fL1 of the first lens unit L1 increases excessively (refractive power becomes excessively weak) so that fL1/fL2 becomes higher than the upper limit of inequality (2) or becomes lower than the lower limit of inequality (2), the correction of chromatic aberration at the telephoto end becomes difficult.

Inequalities (1) and (2) may be replaced with inequalities (1a) and (2a) below:

$$4.5 \leq D 2 t / D 2 w \leq 14. \qquad ( 1 a )$$

$$- 2. \leq fL 1 / fL 2 \leq 2.0 \qquad ( 2 a )$$

Inequalities (1) and (2) may be replaced with inequalities (1b) and (2b) below:

$$4.6 \leq D 2 t / D 2 w \leq 13. \qquad ( 1 b )$$

$$- 1.5 \leq fL 1 / fL 2 \leq 1.5 \qquad ( 2 b )$$

By satisfying the above configuration and inequalities, a zoom lens L0 having a reduced size and weight, and high optical performance over an entire zoom range can be obtained.

The zoom lens L0 according to each example may satisfy at least one of the following inequalities (3) to (13):

$$0.15 \leq \vert ML 1 / TLw \vert \leq 0.9 \qquad ( 3 )$$

$$0.05 \leq \vert ML 3 / TLw \vert \leq 0.4 \qquad ( 4 )$$

$$0.05 \leq \vert ML 3 / ML 1 \vert \leq 0.8 \qquad ( 5 )$$

$$\vert ML 2 / ML 1 \vert \leq 0.2 \qquad ( 6 )$$

$$\vert ML 2 / ML 3 \vert \leq 0.4 \qquad ( 7 )$$

$$0.03 \leq Skw / fL 1 \leq 0.5 \qquad ( 8 )$$

$$0.2 \leq \vert MF 1 / MF 2 \vert \leq 5. \qquad ( 9 )$$

$$60 \leq vdL 1 Pave . \leq 99 \qquad ( 10 )$$

$$60 \leq vdL 2 Pave . \leq 99 \qquad ( 11 )$$

$$20 \leq vdL 2 Nave . \leq 45 \qquad ( 12 )$$

$$1.4 \leq ndG 1 \leq 1.7 \qquad ( 13 )$$

Inequality (3) defines a proper relationship between a moving amount ML1 of the first lens unit L1 during zooming from the wide-angle end to the telephoto end and an overall optical length TLw of the zoom lens L0 at the wide-angle end. The moving amount of a lens unit during zooming from the wide-angle end to the telephoto end is a difference between positions of the lens unit on the optical axis at the wide-angle end and the telephoto end and does not include a reciprocating moving amount. The sign of the moving amount is positive when the lens unit is located on the image side at the telephoto end compared to the wide-angle end. The overall optical length TLw is a distance on the optical axis from the frontmost surface of the zoom lens L0 to the image plane IP. In a case where the moving amount ML1 of the first lens unit L1 becomes excessively small so that |ML1/TLw| becomes lower than the lower limit of inequality (3), securing a high zoom ratio becomes difficult. In a case where the moving amount ML1 becomes excessively large so that |ML1/TLw| becomes higher than the upper limit of inequality (3), the size reduction of the zoom lens L0 at the telephoto end becomes difficult.

Inequality (4) defines a proper relationship between a moving amount ML3 of the third lens unit L3 disposed closest to the object in the rear group LR and the overall optical length TLw of the zoom lens L0 at the wide-angle end during zooming from the wide-angle end to the telephoto end. In a case where the moving amount ML3 of the third lens unit L3 becomes excessively small so that |ML3/TLw becomes lower than the lower limit of inequality (4), securing a high zoom ratio becomes difficult. In a case where the moving amount ML3 becomes excessively large so that |ML3/TLw| becomes higher than the upper limit of inequality (4), the size reduction of the zoom lens L0 at the wide-angle end becomes difficult.

Inequality (5) defines a proper relationship between the moving amount ML1 of the first lens unit L1 and the moving amount ML3 of the third lens unit L3 during zooming from the wide-angle end to the telephoto end. In a case where the moving amount ML1 of the first lens unit L1 becomes excessively small so that |ML3/ML1| becomes lower than the lower limit of inequality (5), securing a high zoom ratio becomes difficult. In a case where the moving amount ML1 becomes excessively large so that |ML3/ML1| becomes higher than the upper limit of inequality (5), the size reduction of the zoom lens L0 at the telephoto end becomes difficult.

Inequality (6) defines a proper relationship between the moving amount ML2 of the second lens unit L2 and the moving amount ML1 of the first lens unit L1 during zooming from the wide-angle end to the telephoto end. In a case where the moving amount ML2 of the second lens unit L2 becomes excessively large so that |ML2/ML1| becomes higher than the upper limit of inequality (6), the size reduction of the zoom lens L0 at the wide-angle end becomes difficult.

Inequality (7) defines a proper relationship between the moving amount ML2 of the second lens unit L2 and the moving amount ML3 of the third lens unit L3 during zooming from the wide-angle end to the telephoto end. In a case where the moving amount ML2 of the second lens unit L2 becomes excessively large so that |ML2/ML3| becomes higher than the upper limit of inequality (7), the size reduction of the zoom lens L0 at the wide-angle end becomes difficult.

Inequality (8) defines a proper relationship between a back focus Skw of the zoom lens L0 at the wide-angle end and the focal length fL1 of the first lens unit L1. In a case where the back focus Skw at the wide-angle end becomes excessively short so that Skw/fL1 becomes lower than the lower limit of inequality (8), placing an optical element such as a low-pass filter near the image plane IP where an imaging surface of the image sensor is disposed becomes difficult. In a case where the back focus Skw becomes excessively long so that Skw/fL1 becomes higher than the upper limit of inequality (8), the overall optical length of the zoom lens L0 at the wide-angle end increases and the size reduction becomes difficult.

Inequality (9) defines a proper relationship between a moving amount MF1 of the first focus lens unit during focusing from an object at infinity to an object at the close distance at the telephoto end and a moving amount MF2 of the second focus lens unit during focusing from the object at infinity to the object at the close distance at the telephoto end. The moving amount of a focus lens unit during focusing from the object at infinity to the object at the close distance is a difference between positions on the optical axis at which the focus lens unit focuses on the object at infinity and the object at the close distance, respectively, and does not include a reciprocating moving amount. When a focusing position for the object at the close distance is on the object side relative to a focusing position for the object at infinity, the sign of the moving amount of the focus lens unit is positive. In a case where the moving amount MF1 of the first focus lens unit becomes excessively small so that |MF1/MF2| becomes lower than the lower limit of inequality (9), variations in spherical aberration and other aberrations during focusing become difficult to suppress. In a case where the moving amount MF1 of the first focus lens unit becomes excessively large so that |MF1/MF2| becomes higher than the upper limit of inequality (9), variations in spherical aberration and other aberrations during focusing become large.

Inequality (10) defines a proper range of an average Abbe number vdL1Pave. based on the d-line of all positive lenses among positive lenses included in the first lens unit L1. In a case where vdL1Pave. becomes lower than the lower limit of inequality (10), the correction of longitudinal and lateral chromatic aberrations at the telephoto end becomes difficult. In a case where vdL1Pave. becomes higher than the upper limit of inequality (10), dispersions of all positive lenses included in the first lens unit L1 become excessively small, and the correction of lateral chromatic aberration at the wide-angle end becomes difficult.

Inequality (11) defines a proper range of an average Abbe number vdL2Pave. based on the d-line of all positive lenses among positive lenses included in the second lens unit L2. In a case where vdL2Pave. becomes lower than the lower limit of inequality (11), the correction of longitudinal and lateral chromatic aberrations at the telephoto end becomes difficult. In a case where vdL2Pave. becomes higher than the upper limit of inequality (11), dispersions of all positive lenses included in the second lens unit L2 become excessively small, and the correction of lateral chromatic aberration at the wide-angle end becomes difficult.

Inequality (12) defines a proper range of an average Abbe number vdL2Nave. based on the d-line of all negative lenses among negative lenses included in the second lens unit L2. In a case where vdL2Nave. becomes lower than the lower limit of inequality (12), the correction of lateral chromatic aberration at the wide-angle end becomes difficult. In a case where vdL2Nave. becomes higher than the upper limit of inequality (12), the correction of longitudinal and lateral chromatic aberrations at the telephoto end becomes difficult.

Inequality (13) defines a proper range of a refractive index ndG1 at the d-line of a positive lens G1 closest to the object in the first lens unit L1. In a case where ndG1 becomes lower than the lower limit of inequality (13), the curvature of a surface becomes large in order to obtain necessary refractive power, and, as a result, higher-order spherical aberration occurs. In a case where ndG1 becomes higher than the upper limit of inequality (13), this configuration is beneficial in terms of the size reduction of the first lens unit L1, but refractive power becomes excessively strong, and compatibility between the correction of spherical aberration and the correction of distortion becomes difficult.

Inequalities (3) to (13) may be replaced with inequalities (3a) to (13a) below:

$$0.2 \leq \vert ML 1 / TLw \vert \leq 0.8 \qquad ( 3 a )$$

$$0.07 \leq \vert ML 3 / TLw \vert \leq 0.3 \qquad ( 4 a )$$

$$0.1 \leq \vert ML 3 / ML 1 \vert \leq 0.7 \qquad ( 5 a )$$

$$\vert ML 2 / ML 1 \vert \leq 0.1 \qquad ( 6 a )$$

$$\vert ML 2 / ML 3 \vert \leq 0.3 \qquad ( 7 a )$$

$$0.04 \leq Skw / fL 1 \leq 0.4 \qquad ( 8 a )$$

$$0.25 \leq \vert MF 1 / MF 2 \vert \leq 4. \qquad ( 9 a )$$

$$63 \leq vdL 1 Pave . \leq 97 \qquad ( 10 a )$$

$$65 \leq vdL 2 Pave . \leq 97 \qquad ( 11 a )$$

$$23 \leq vdL 2 Nave . \leq 40 \qquad ( 12 a )$$

$$1.42 \leq ndG 1 \leq 1.65 \qquad ( 13 a )$$

Inequalities (3) to (13) may be replaced with inequalities (3b) to (13b) below:

$$0.25 \leq \vert ML 1 / TLw \vert \leq 0.75 \qquad ( 3 b )$$

$$0.1 \leq \vert ML 3 / TLw \vert \leq 0.25 \qquad ( 4 b )$$

$$0.15 \leq \vert ML 3 / ML 1 \vert \leq 0.6 \qquad ( 5 b )$$

$$\vert ML 2 / ML 1 \vert \leq 0.05 \qquad ( 6 b )$$

$$\vert ML 2 / ML 3 \vert \leq 0.2 \qquad ( 7 b )$$

$$0.05 \leq Skw / fL 1 \leq 0.3 \qquad ( 8 b )$$

$$0.3 \leq \vert MF 1 / MF 2 \vert \leq 3. \qquad ( 9 b )$$

$$65 \leq vdL 1 Pave . \leq 96 \qquad ( 10 b )$$

$$70 \leq vdL 2 Pave . \leq 96 \qquad ( 11 b )$$

$$25 \leq vdL 2 Nave . \leq 37 \qquad ( 12 b )$$

$$1.43 \leq ndG 1 \leq 1.6 \qquad ( 13 b )$$

Next, configurations that the zoom lens L0 according to each example may satisfy will be described.

The first lens unit L1 may consist of two or fewer single lenses. This facilitates reduction in weight of the first lens unit L1. In a case where one cemented lens in which a plurality of lenses (for example, two lenses) are cemented is present, the cemented lens is regarded as including a plurality of lenses (two lenses).

The second lens unit L2 may consist of three or fewer lenses. This facilitates a reduction in weight of the second lens unit L2. The third lens unit L3 may consist of four or fewer lenses. The third lens unit L3 may consist of three or fewer lenses. This facilitates a reduction in weight of the third lens unit L3.

The first focus lens unit may consist of three or fewer lenses. This facilitates a reduction in weight of the first focus lens unit. The second focus lens unit may consist of three or fewer lenses. This facilitates a reduction in weight of the second focus lens unit.

The rear group LR may include an image stabilizing unit. When a lens unit as a part of the rear group LR or a partial unit included in the rear group LR is used as the image stabilizing unit, a diameter of the image stabilizing unit reduces, and the size reduction of the zoom lens becomes easier.

The rear group LR may include three or more lens units, and a distance between adjacent lens units may change during zooming. The rear group LR may include four or more lens units, and a distance between adjacent lens units may change during zooming. By moving many lens units during zooming, aberration variation during zooming can be suppressed, and securing a high zoom ratio becomes easier.

The third lens unit L3 may move toward the image side during zooming from the wide-angle end to the telephoto end. By placing the third lens unit L3 on the image side at the telephoto end, reducing the diameter and weight of the third lens unit L3 can become easier.

The aperture stop SP may move independently of the third lens unit L3 during zooming, that is, along a different locus. This facilitates a reduction in diameter of the aperture stop SP and further facilitates the size reduction of the zoom lens L0.

Next, the configuration of the zoom lens L0 according to each example will be specifically described. The zoom lenses L0 according to Example 1 and 2 consist of the first lens unit L1, the second lens unit L2 having negative refractive power, the third lens unit L3 having positive refractive power, the fourth lens unit L4 having negative refractive power, the fifth lens unit L5 having positive refractive power, the sixth lens unit L6 having positive refractive power, and the seventh lens unit L7 having negative refractive power. The fourth lens unit L4 to the seventh lens unit L7 are included in the rear group LR. The aperture stop SP is disposed closest to the object in the fifth lens unit L5.

In the zoom lenses L0 according to Examples 1 and 2, during zooming from the wide-angle end to the telephoto end, the first lens unit L1 moves toward the object side, the second lens unit L2 does not move, the third lens unit L3 and the fourth lens unit L4 move toward the image side, and the fifth lens unit L5 to the seventh lens unit L7 move toward the object side. During focusing from an object at infinity to an object at a close distance, the fourth lens unit L4 moves toward the object side as the first focus lens unit, and the seventh lens unit L7 moves toward the image side as the second focus lens unit.

The zoom lens L0 according to Example 3 consists of the first lens unit L1, the second lens unit L2 having negative refractive power, the third lens unit L3 having negative refractive power, the fourth lens unit L4 having negative refractive power, the fifth lens unit L5 having positive refractive power, the sixth lens unit L6 having negative refractive power, the seventh lens unit L7 having positive refractive power, and the eighth lens unit L8 having negative refractive power. The fourth lens unit L4 to the eighth lens unit L8 are included in the rear group LR. The aperture stop SP is disposed between the fourth lens unit L4 and the fifth lens unit L5.

In the zoom lens L0 according to Example 3, during zooming from the wide-angle end to the telephoto end, the first lens unit L1 moves toward the object side, the second lens unit L2 does not move, the third lens unit L3 and the fourth lens unit L4 move toward the image side, and the fifth lens unit L5 to the eighth lens unit L8 move toward the object side. During focusing from an object at infinity to an object at a close distance, the fourth lens unit L4 moves toward the object side as the first focus lens unit, and the sixth lens unit L6 moves toward the image side as the second focus lens unit.

The zoom lens L0 according to Example 4 consists of the first lens unit L1, the second lens unit L2 having positive refractive power, the third lens unit L3 having positive refractive power, the fourth lens unit L4 having negative refractive power, the fifth lens unit L5 having positive refractive power, the sixth lens unit L6 having negative refractive power, the seventh lens unit L7 having positive refractive power, and the eighth lens unit L8 having negative refractive power. The fourth lens unit L4 to the eighth lens unit L8 are included in the rear group LR. The aperture stop SP is disposed between the fourth lens unit L4 and the fifth lens unit L5.

In the zoom lens L0 according to Example 4, during zooming from the wide-angle end to the telephoto end, the first lens unit L1 and the second lens unit L2 move toward the object side, the third lens unit L3 and the fourth lens unit L4 move toward the image side, and the fifth lens unit L5 to the eighth lens unit L8 move toward the object side. During focusing from an object at infinity to an object at a close distance, the fourth lens unit L4 moves toward the object side as the first focus lens unit, and the sixth lens unit L6 moves toward the image side as the second focus lens unit.

The zoom lens L0 according to Example 5 consists of the first lens unit L1, the second lens unit L2 having positive refractive power, the third lens unit L3 having negative refractive power, the fourth lens unit L4 having negative refractive power, the fifth lens unit L5 having positive refractive power, the sixth lens unit L6 having negative refractive power, the seventh lens unit L7 having positive refractive power, and the eighth lens unit L8 having negative refractive power. The fourth lens unit L4 to the eighth lens unit L8 are included in the rear group LR. The aperture stop SP is disposed between the fourth lens unit L4 and the fifth lens unit L5.

In the zoom lens L0 according to Example 5, during zooming from the wide-angle end to the telephoto end, the first lens unit L1 moves toward the object side, the second lens unit L2 to the fourth lens unit L4 move toward the image side, and the fifth lens unit L5 to the eighth lens unit L8 move toward the object side. During focusing from an object at infinity to an object at a close distance, the fourth lens unit L4 moves toward the object side as the first focus lens unit, and the sixth lens unit L6 moves toward the image side as the second focus lens unit.

The zoom lens L0 according to Example 6 consists of the first lens unit L1, the second lens unit L2 having positive refractive power, the third lens unit L3 having negative refractive power, the fourth lens unit L4 having positive refractive power, the fifth lens unit L5 having negative refractive power, the sixth lens unit L6 having positive refractive power, the seventh lens unit L7 having negative refractive power, and the eighth lens unit L8 having positive refractive power. The third lens unit L3 to the eighth lens unit L8 are included in the rear group LR. The aperture stop SP is disposed in the fourth lens unit L4.

In the zoom lens L0 according to Example 6, during zooming from the wide-angle end to the telephoto end, the first lens unit L1 moves toward the object side, the second lens unit L2 does not move, and the third lens unit L3 moves toward the image side. Further, the fourth lens unit L4 to the seventh lens unit L7 move toward the object side, and the eighth lens unit L8 does not move. During focusing from an object at infinity to an object at a close distance, the fifth lens unit L5 moves toward the image side as the first focus lens unit, and the seventh lens unit L7 moves toward the image side as the second focus lens unit.

Numerical examples 1 to 6 corresponding to Examples 1 to 6, respectively, will be described below. In surface data of each numerical example, a surface number i indicates an order of a surface counted from the object side. r represents a radius of curvature (mm) of an i-th surface, d represents a lens thickness or an air gap (mm) on the optical axis between i-th and (i+1)-th surfaces, and nd represents a refractive index at the d-line of an optical material between i-th and (i+1)-th surfaces. vd represents an Abbe number based on the d-line of the optical material between i-th and (i+1)-th surfaces. The Abbe number vd based on the d-line is expressed as follows:

$$ν d = ( Nd - 1 ) / ( NF - NC )$$

where Nd, NF, and NC are refractive indices for d-line (587.6 nm), F-line (486.1 nm), and C-line (656.3 nm) in the Fraunhofer line, respectively.

d, focal length (mm), F-number, and half field angle (°) described above are all values in an in-focus state at infinity. BF represents a back focus (mm). The back focus is a distance on the optical axis from a surface closest to the image plane (final surface) of the zoom lens to a paraxial image plane, expressed as an air-converted length. An overall lens length is a length obtained by adding the back focus to a distance on the optical axis from the frontmost surface of the zoom lens to the final surface, and corresponds to an overall optical length. WIDE, MIDDLE, and TELE mean a wide-angle end, an intermediate zoom position, and a telephoto end, respectively.

An asterisk “*” appended to a surface number means that the surface has an aspherical shape. The aspherical shape is expressed by the following equation, where X is a displacement amount from a surface vertex in an optical axis direction, h is a height from the optical axis in a direction perpendicular to the optical axis, a traveling direction of light is positive, R is a paraxial radius of curvature, K is a conic constant, and A4, A6, A8, A10, A12, and A14 are aspherical coefficients. In the conic constant and the aspherical coefficients, “e±XX” means “×10^{±XX}”

$$X = ( {h}^{2} / R ) / [ 1 + {[ 1 - ( 1 + K ) {( h / R )}^{2} ]}^{1 / 2} ] + A 4 \times {h}^{4} + A 6 \times {h}^{6} + A 8 \times {h}^{8} + A 10 \times {h}^{10} + A 12 \times {h}^{12} + A 14 \times {h}^{14}$$

Table 1 summarizes values relating to inequalities (1) to (13) in the respective numerical examples. Numerical examples 1 to 6 satisfy inequalities (1) to (13).

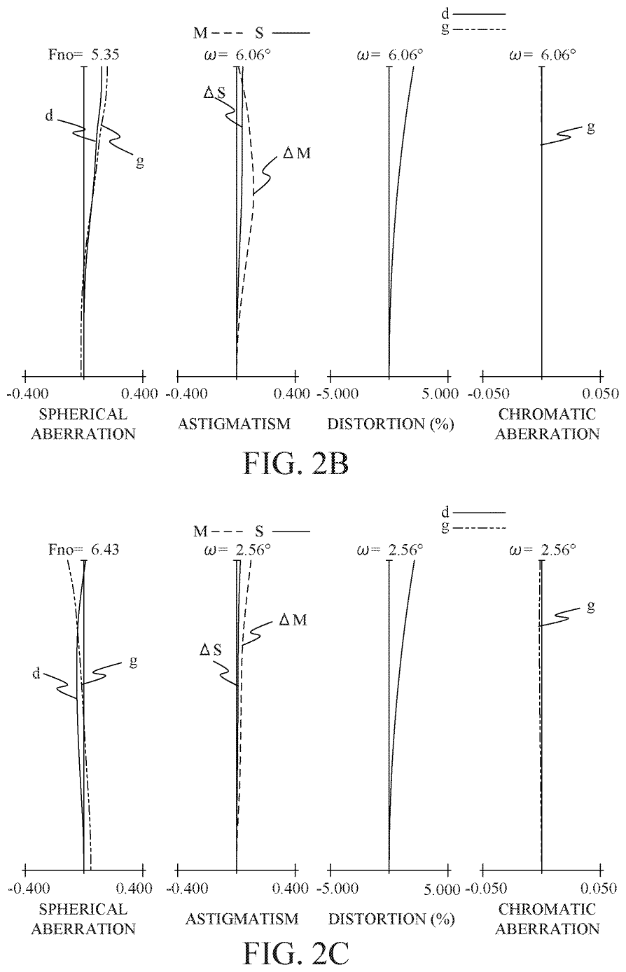

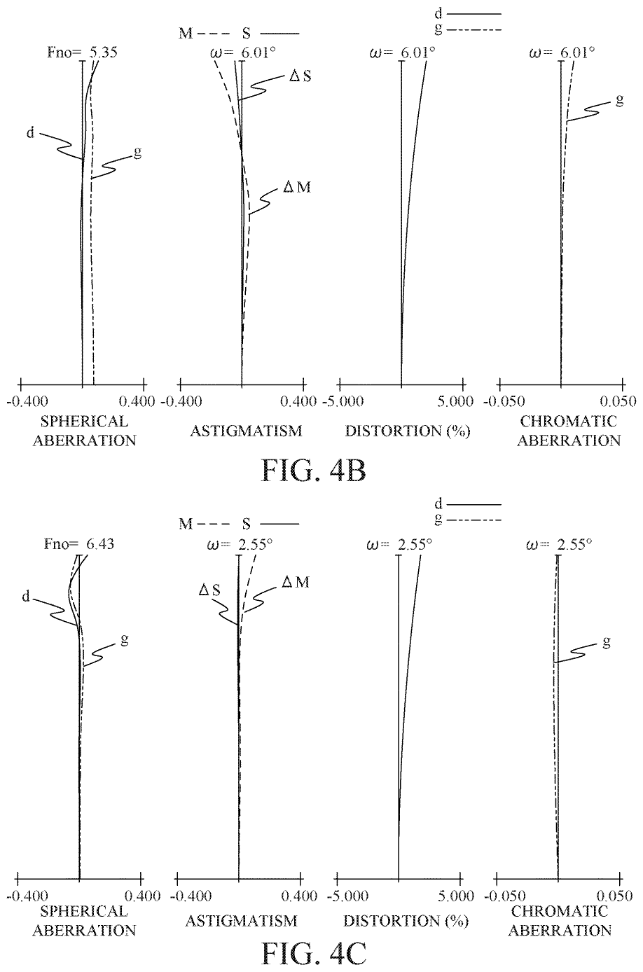

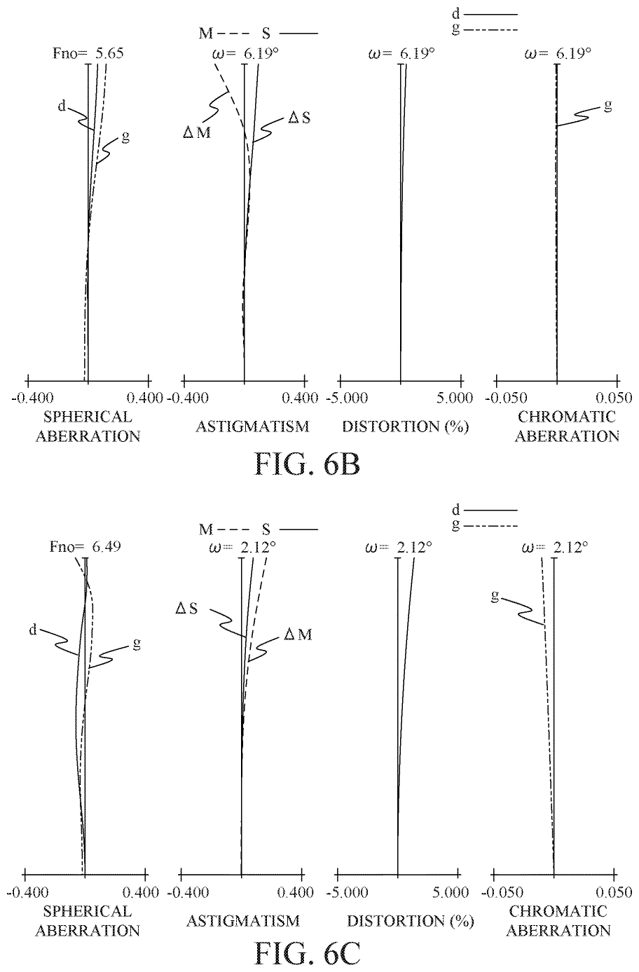

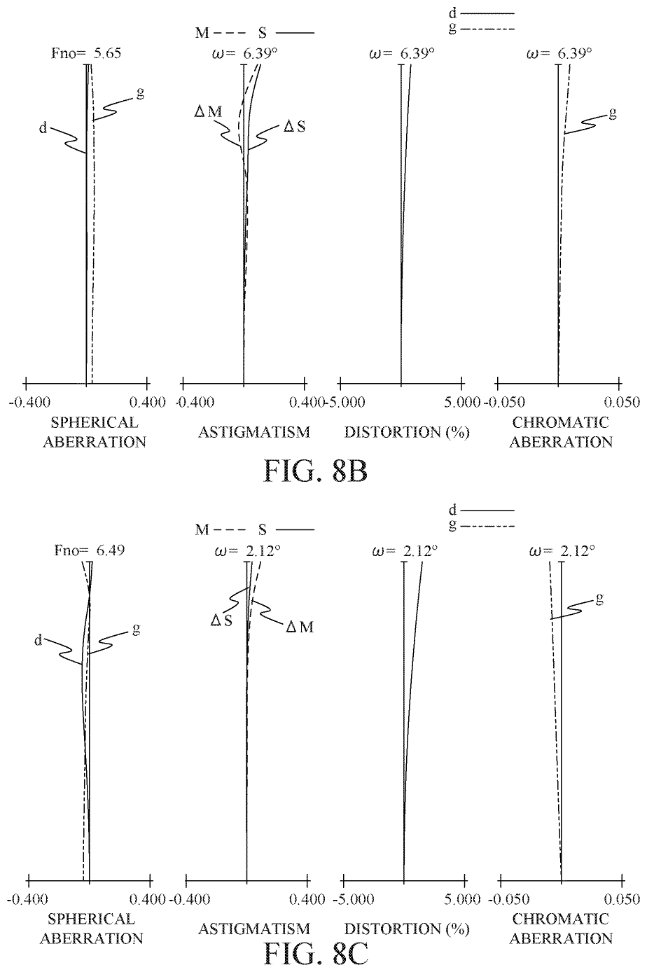

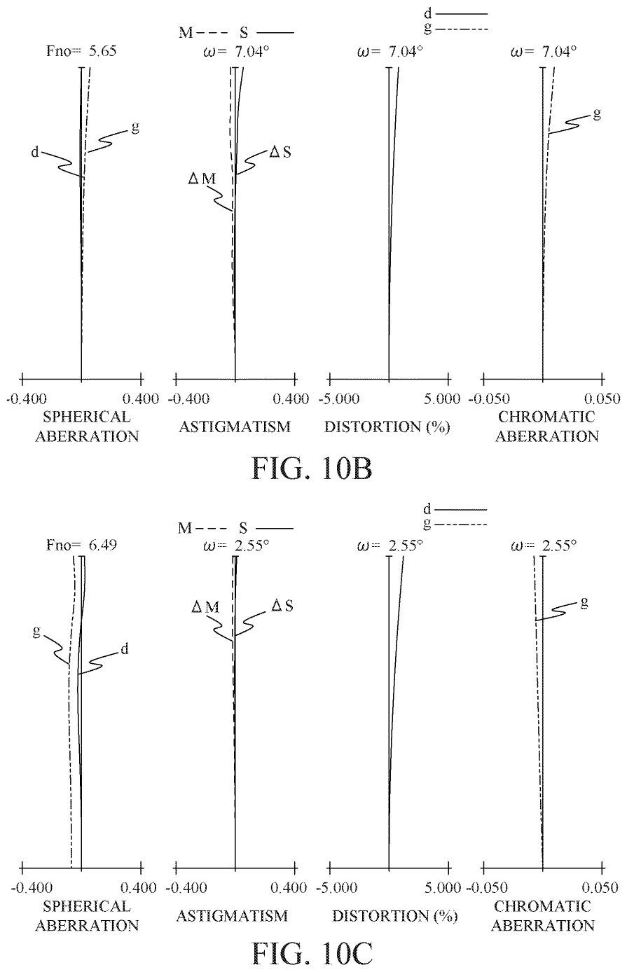

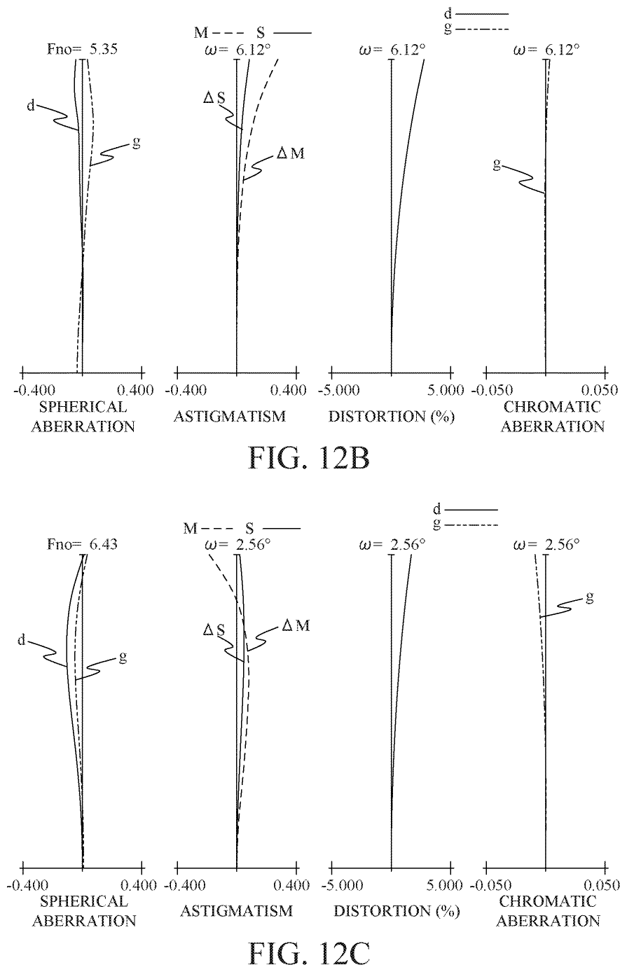

FIGS. 2A, 4A, 6A, 8A, 10A, and 12A respectively illustrate longitudinal aberrations (spherical aberration, astigmatism, distortion, and chromatic aberration) of the zoom lenses L0 according to numerical examples 1 to 6 at a wide-angle end in an in-focus state at infinity. FIGS. 2B, 4B, 6B, 8B, 10B, and 12B respectively illustrate longitudinal aberrations of the zoom lenses L0 according to numerical examples 1 to 6 at an intermediate zoom position in the in-focus state at infinity. FIGS. 2C, 4C, 6C, 8C, 10C, and 12C respectively illustrate longitudinal aberrations of the zoom lenses L0 according to numerical examples 1 to 6 at a telephoto end in the in-focus state at infinity.

In the spherical aberration diagram, Fno indicates an F-number, a solid line indicates a spherical aberration amount for the d-line (wavelength: 587.6 nm), and an alternate long and two short dashes line indicates a spherical aberration amount for the g-line (wavelength: 435.8 nm). In the astigmatism diagram, a solid line ΔS indicates an astigmatism amount on a sagittal image plane, and a dashed line ΔM indicates an astigmatism amount on a meridional image plane. The distortion diagram indicates a distortion amount for the d-line. The chromatic aberration diagram indicates a lateral chromatic aberration amount for the g-line. @ indicates a half field angle (°) and represents an angle of view obtained by paraxial calculation.

NUMERICAL EXAMPLE 1
UNIT: mm
SURFACE DATA

| Surface No. | r | d | nd | νd |
|---|---|---|---|---|
| 1 | 164.651 | 6.49 | 1.49700 | 81.5 |
| 2 | −992.849 | (Variable) | | |
| 3 | 54.679 | 8.78 | 1.43387 | 95.1 |
| 4 | −164.854 | 0.10 | | |
| 5 | −177.402 | 1.25 | 1.77047 | 29.7 |
| 6 | 88.934 | (Variable) | | |
| 7 | 125.120 | 4.12 | 1.85478 | 24.8 |
| 8 | −202.791 | 0.15 | | |
| 9 | −3344.207 | 1.20 | 1.59282 | 68.6 |
| 10 | 57.245 | (Variable) | | |
| 11 | −55.760 | 1.20 | 1.59282 | 68.6 |
| 12 | 53.178 | 1.99 | 1.91650 | 31.6 |
| 13 | 102.063 | (Variable) | | |
| 14 (SP) | ∞ | 0.30 | | |
| 15 | 29.957 | 7.74 | 1.43387 | 95.1 |
| 16 | −327.003 | 0.15 | | |
| 17 | 28.976 | 5.20 | 1.49700 | 81.7 |
| 18 | 94.576 | 5.59 | | |
| 19 | −170.402 | 1.15 | 1.80610 | 40.7 |
| 20 | 25.369 | 1.99 | | |
| 21 | 30.481 | 4.64 | 1.49700 | 81.7 |
| 22 | −186.228 | 0.90 | 1.89286 | 20.4 |
| 23 | 53.091 | 0.10 | 1.58946 | 30.6 |
| 24* | 57.945 | 0.15 | | |
| 25 | 47.373 | 4.16 | 1.77047 | 29.7 |
| 26 | −71.660 | 0.95 | | |
| 27 | 86.275 | 5.37 | 1.89286 | 20.4 |
| 28 | −25.672 | 0.90 | 1.91082 | 35.2 |
| 29 | 29.058 | (Variable) | | |
| 30 | 28.044 | 5.65 | 1.72047 | 34.7 |
| 31 | −35.472 | 1.00 | 1.95906 | 17.5 |
| 32 | −370.146 | (Variable) | | |
| 33 | 1623.915 | 0.80 | 1.90043 | 37.4 |
| 34 | 28.414 | 5.20 | 1.66565 | 35.6 |
| 35 | −40.950 | 0.10 | 1.58946 | 30.6 |
| 36* | −40.526 | 0.91 | | |
| 37 | −30.022 | 0.90 | 1.49700 | 81.7 |
| 38 | 44.272 | (Variable) | | |
| Image Plane | ∞ | | | |

ASPHERIC DATA
24th Surface
K = 0.00000e+00 A 4 = 7.41455e−06 A 6 = 2.87737e−09
A 8 = −2.41337e−11 A10 = 1.40485e−13 A12 = −2.80246e−16
36th Surface
K = 0.00000e+00 A 4 = −3.89934e−06 A 6 = −1.16405e−08
A 8 = 2.43384e−10 A10 = −2.46472e−12 A12 = 9.07277e−15

VARIOUS DATA

| | |
|---|---|
| ZOOM RATIO | 4.70 |

| | WIDE | MIDDLE | TELE |
|---|---|---|---|
| Focal Length | 103.18 | 203.65 | 484.84 |
| Fno | 4.63 | 5.35 | 6.43 |
| Half Angle of View (°) | 11.84 | 6.06 | 2.56 |
| Image Height | 21.64 | 21.64 | 21.64 |
| Overall Lens Length | 238.21 | 282.76 | 337.21 |
| BF | 57.29 | 67.63 | 91.05 |
| d2 | 0.90 | 45.45 | 99.90 |
| d6 | 1.69 | 14.42 | 34.11 |
| d10 | 18.44 | 26.09 | 24.83 |
| d13 | 71.89 | 38.03 | 3.11 |
| d29 | 0.66 | 1.56 | 2.85 |
| d32 | 8.22 | 10.47 | 2.25 |
| d38 | 57.29 | 67.63 | 91.05 |

LENS UNIT DATA

| Lens Unit | Starting Surface | Focal Length |
|---|---|---|
| 1 | 1 | 284.69 |
| 2 | 3 | −530.88 |
| 3 | 7 | 1405.98 |
| 4 | 11 | −73.58 |
| 5 | 14 | 100.94 |
| 6 | 30 | 45.71 |
| 7 | 33 | −52.14 |

NUMERICAL EXAMPLE 2
UNIT: mm
SURFACE DATA

| Surface No. | r | d | nd | νd |
|---|---|---|---|---|
| 1 | 215.133 | 5.22 | 1.43875 | 94.7 |
| 2 | −1177.812 | (Variable) | | |
| 3 | 61.606 | 8.31 | 1.43387 | 95.1 |
| 4 | −135.709 | 0.10 | | |
| 5 | −161.855 | 1.25 | 1.77047 | 29.7 |
| 6 | 94.133 | (Variable) | | |
| 7 | 165.786 | 3.43 | 2.00069 | 25.5 |
| 8 | −234.343 | 0.15 | | |
| 9 | 480.831 | 1.20 | 1.49700 | 81.7 |
| 10 | 63.848 | (Variable) | | |
| 11 | −62.530 | 1.20 | 1.59282 | 68.6 |
| 12 | 57.960 | 2.45 | 1.89190 | 37.1 |
| 13 | 117.437 | (Variable) | | |
| 14 (SP) | ∞ | 0.30 | | |
| 15 | 31.104 | 9.11 | 1.43387 | 95.1 |
| 16 | −229.645 | 0.15 | | |
| 17 | 29.443 | 4.72 | 1.49700 | 81.7 |
| 18 | 71.851 | 7.75 | | |
| 19 | −105.672 | 1.15 | 1.75500 | 52.3 |
| 20 | 26.867 | 2.59 | | |
| 21* | 34.801 | 4.37 | 1.49700 | 81.7 |
| 22 | −146.809 | 0.90 | 1.86966 | 20.0 |
| 23 | 74.586 | 0.15 | | |
| 24 | 78.321 | 3.30 | 1.80518 | 25.5 |
| 25 | −87.066 | 0.95 | | |
| 26 | 58.772 | 7.13 | 1.89286 | 20.4 |
| 27 | −26.869 | 0.90 | 1.96300 | 24.1 |
| 28 | 31.789 | (Variable) | | |
| 29 | 33.056 | 5.09 | 1.73037 | 32.2 |
| 30 | −68.071 | 1.00 | 1.95906 | 17.5 |
| 31 | −427.866 | (Variable) | | |
| 32 | 97.457 | 0.80 | 1.90043 | 37.4 |
| 33 | 17.340 | 10.09 | 1.60342 | 38.0 |
| 34 | −26.337 | 0.80 | | |
| 35* | −20.317 | 0.90 | 1.49700 | 81.7 |
| 36* | 51.161 | (Variable) | | |
| Image Plane | ∞ | | | |

ASPHERIC DATA
21st Surface
K = 0.00000e+00 A 4 = −4.85175e−06 A 6 = 9.97592e−10
A 8 = −1.83474e−11 A10 = 1.53669e−13 A12 = −4.61385e−16
35th Surface
K = 0.00000e+00 A 4 = 6.09133e−06 A 6 = 1.24869e−07
A 8 = −8.74896e−10 A10 = 2.74942e−12 A12 = 1.35020e−15
36th Surface
K = 0.00000e+00 A 4 = −1.34235e−05 A 6 = 9.27560e−08
A 8 = −8.88026e−10 A10 = 2.96304e−12 A12 = −2.48349e−15

VARIOUS DATA

| | |
|---|---|
| ZOOM RATIO | 4.71 |

| | WIDE | MIDDLE | TELE |
|---|---|---|---|
| Focal Length | 103.03 | 205.48 | 484.97 |
| Fno | 4.63 | 5.35 | 6.43 |
| Half Angle of View (°) | 11.86 | 6.01 | 2.55 |
| Image Height | 21.64 | 21.64 | 21.64 |
| Overall Lens Length | 239.52 | 312.59 | 401.90 |
| BF | 45.64 | 67.32 | 97.77 |
| d2 | 0.90 | 73.97 | 163.28 |
| d6 | 2.04 | 12.66 | 32.86 |
| d10 | 14.46 | 18.66 | 15.52 |
| d13 | 82.05 | 46.16 | 3.34 |
| d28 | 1.12 | 2.71 | 3.41 |
| d31 | 7.87 | 5.66 | 0.28 |
| d36 | 45.64 | 67.32 | 97.77 |

LENS UNIT DATA

| Lens Unit | Starting Surface | Focal Length |
|---|---|---|
| 1 | 1 | 415.08 |
| 2 | 3 | −442.00 |
| 3 | 7 | 273.06 |
| 4 | 11 | −83.51 |
| 5 | 14 | 107.00 |
| 6 | 29 | 47.56 |
| 7 | 32 | −52.06 |

NUMERICAL EXAMPLE 3
UNIT: mm
SURFACE DATA

| Surface No. | r | d | nd | νd |
|---|---|---|---|---|
| 1 | 180.558 | 8.49 | 1.49700 | 81.5 |
| 2 | −1632.774 | (Variable) | | |
| 3 | 66.970 | 10.00 | 1.43387 | 95.1 |
| 4 | −292.843 | 0.03 | | |
| 5 | −331.366 | 1.45 | 1.80610 | 33.3 |
| 6 | 119.345 | (Variable) | | |
| 7 | 286.937 | 3.06 | 1.85478 | 24.8 |
| 8 | −196.659 | 0.15 | | |
| 9 | −658.113 | 1.25 | 1.59282 | 68.6 |
| 10 | 74.834 | (Variable) | | |
| 11 | −63.788 | 1.20 | 1.59282 | 68.6 |
| 12 | 87.224 | 2.18 | 1.77047 | 29.7 |
| 13 | 232.533 | (Variable) | | |
| 14 (SP) | ∞ | (Variable) | | |
| 15 | 39.833 | 8.03 | 1.43387 | 95.1 |
| 16 | −176.245 | 0.15 | | |
| 17 | 53.637 | 4.41 | 1.49700 | 81.5 |
| 18 | 777.726 | 0.15 | | |
| 19 | 47.028 | 6.56 | 1.49700 | 81.5 |
| 20 | −76.418 | 1.40 | 1.75500 | 52.3 |
| 21 | 55.274 | 14.53 | | |
| 22 | −98.263 | 2.73 | 1.66565 | 35.6 |
| 23 | −30.173 | 1.00 | 1.72916 | 54.7 |
| 24 | 34.552 | 1.50 | | |
| 25 | 52.362 | 1.00 | 1.95906 | 17.5 |
| 26 | 39.279 | 4.11 | 1.48749 | 70.2 |
| 27 | −61.481 | 0.10 | 1.58946 | 30.6 |
| 28* | −79.328 | 0.15 | | |
| 29 | 38.935 | 2.99 | 1.61340 | 44.3 |
| 30 | 789.408 | (Variable) | | |
| 31 | 237.194 | 1.92 | 1.77047 | 29.7 |
| 32 | −114.123 | 0.85 | 1.88300 | 40.8 |
| 33 | 68.900 | (Variable) | | |
| 34 | −257.247 | 2.43 | 1.56732 | 42.8 |
| 35 | −59.691 | (Variable) | | |
| 36 | −42.272 | 1.20 | 1.43875 | 94.7 |
| 37 | 88.047 | 8.14 | 1.51742 | 52.4 |
| 38 | −26.932 | 1.20 | 1.49700 | 81.5 |
| 39 | 218.375 | (Variable) | | |
| Image Plane | ∞ | | | |

ASPHERIC DATA
28th Surface
K = 0.00000e+00 A 4 = 6.76027e−07 A 6 = 2.49893e−09
A 8 = −2.91480e−11 A10 = 1.94933e−13 A12 = −4.85325e−16

VARIOUS DATA

| | |
|---|---|
| ZOOM RATIO | 5.66 |

| | WIDE | MIDDLE | TELE |
|---|---|---|---|
| Focal Length | 103.31 | 199.40 | 584.79 |
| Fno | 4.63 | 5.65 | 6.49 |
| Half Angle of View (°) | 11.83 | 6.19 | 2.12 |
| Image Height | 21.64 | 21.64 | 21.64 |
| Overall Lens Length | 284.16 | 346.98 | 389.09 |
| BF | 37.71 | 39.02 | 78.98 |
| d2 | 0.90 | 63.72 | 105.83 |
| d6 | 2.50 | 29.42 | 51.02 |
| d10 | 15.39 | 26.31 | 26.80 |
| d13 | 62.94 | 25.10 | 3.02 |
| d14 | 35.60 | 35.61 | −0.28 |
| d30 | 2.00 | 7.47 | 1.34 |
| d33 | 27.87 | 22.41 | 28.54 |
| d35 | 6.90 | 5.58 | 1.51 |
| d39 | 37.71 | 39.02 | 78.98 |

LENS UNIT DATA

| Lens Unit | Starting Surface | Focal Length |
|---|---|---|
| 1 | 1 | 327.63 |
| 2 | 3 | −1181.41 |
| 3 | 7 | −701.45 |
| 4 | 11 | −94.26 |
| 5 | 15 | 62.25 |
| 6 | 31 | −95.31 |
| 7 | 34 | 136.40 |
| 8 | 36 | −90.07 |

NUMERICAL EXAMPLE 4
UNIT: mm
SURFACE DATA

| Surface No. | r | d | nd | νd |
|---|---|---|---|---|
| 1 | 269.981 | 4.95 | 1.59349 | 67.0 |
| 2 | 2061.875 | (Variable) | | |
| 3 | 77.510 | 7.78 | 1.43387 | 95.1 |
| 4 | −341.399 | 0.30 | | |
| 5 | −297.104 | 1.45 | 1.80610 | 33.3 |
| 6 | 79.900 | 0.14 | | |
| 7 | 81.238 | 6.06 | 1.43387 | 95.1 |
| 8 | −882.841 | (Variable) | | |
| 9 | 262.461 | 3.71 | 1.85478 | 24.8 |
| 10 | −157.690 | 0.15 | | |
| 11 | −573.290 | 1.25 | 1.59282 | 68.6 |
| 12 | 93.819 | (Variable) | | |
| 13 | −183.917 | 1.20 | 1.59282 | 68.6 |
| 14 | 65.292 | 3.13 | 1.66565 | 35.6 |
| 15 | 419.646 | 3.25 | | |
| 16 | −56.219 | 1.00 | 1.43875 | 94.7 |
| 17 | 387.874 | (Variable) | | |
| 18 (SP) | ∞ | (Variable) | | |
| 19 | 40.123 | 7.64 | 1.43387 | 95.1 |
| 20 | −178.847 | 0.15 | | |
| 21 | 60.169 | 3.76 | 1.59282 | 68.6 |
| 22 | 520.049 | 0.15 | | |
| 23 | 45.371 | 6.66 | 1.49700 | 81.7 |
| 24 | −76.645 | 1.40 | 1.72916 | 54.7 |
| 25 | 52.490 | 16.28 | | |
| 26 | −72.032 | 2.82 | 1.73037 | 32.2 |
| 27 | −25.361 | 1.00 | 1.74400 | 44.8 |
| 28 | 34.670 | 2.66 | | |
| 29 | 55.716 | 1.00 | 1.95906 | 17.5 |
| 30 | 39.268 | 4.08 | 1.48749 | 70.2 |
| 31* | −81.737 | 0.15 | | |
| 32 | 39.223 | 3.57 | 1.61340 | 44.3 |
| 33 | −276.942 | (Variable) | | |
| 34 | 463.197 | 1.89 | 1.68430 | 26.8 |
| 35 | −108.432 | 0.85 | 1.88300 | 40.8 |
| 36 | 65.081 | (Variable) | | |
| 37 | 4254.102 | 3.91 | 1.53172 | 48.8 |
| 38 | −50.478 | (Variable) | | |
| 39 | −41.498 | 1.20 | 1.43875 | 94.7 |
| 40 | 83.511 | 7.50 | 1.51742 | 52.4 |
| 41 | −35.690 | 1.20 | 1.43875 | 94.7 |
| 42 | 123.111 | (Variable) | | |
| Image Plane | ∞ | | | |

ASPHERIC DATA
31st Surface
K = 0.00000e+00 A 4 = 1.15289e−06 A 6 = −5.59256e−10
A 8 = 1.61123e−11 A10 = −4.37103e−14 A12 = −1.07538e−16

VARIOUS DATA

| | |
|---|---|
| ZOOM RATIO | 5.68 |

| | WIDE | MIDDLE | TELE |
|---|---|---|---|
| Focal Length | 103.05 | 193.32 | 584.97 |
| Fno | 4.64 | 5.65 | 6.49 |
| Half Angle of View (°) | 11.86 | 6.39 | 2.12 |
| Image Height | 21.64 | 21.64 | 21.64 |
| Overall Lens Length | 286.09 | 402.13 | 485.09 |
| BF | 37.92 | 39.96 | 76.42 |
| d2 | 0.90 | 116.88 | 199.78 |
| d8 | 0.98 | 21.47 | 40.59 |
| d12 | 10.07 | 20.63 | 31.69 |
| d17 | 61.89 | 30.90 | 0.78 |
| d18 | 35.94 | 34.48 | 2.19 |
| d33 | 1.45 | 4.25 | 1.49 |
| d36 | 28.37 | 25.57 | 28.33 |
| d38 | 6.33 | 5.74 | 1.57 |
| d42 | 37.92 | 39.96 | 76.42 |

LENS UNIT DATA

| Lens Unit | Starting Surface | Focal Length |
|---|---|---|
| 1 | 1 | 522.91 |
| 2 | 3 | 9459.33 |
| 3 | 9 | 722.28 |
| 4 | 13 | −78.06 |
| 5 | 19 | 62.32 |
| 6 | 34 | −71.94 |
| 7 | 37 | 93.85 |
| 8 | 39 | −90.25 |

NUMERICAL EXAMPLE 5
UNIT: mm
SURFACE DATA

| Surface No. | r | d | nd | νd |
|---|---|---|---|---|
| 1 | 249.947 | 2.87 | 1.49700 | 81.7 |
| 2 | 506.076 | 0.15 | | |
| 3 | 159.697 | 5.81 | 1.43387 | 95.1 |
| 4 | 1509.843 | (Variable) | | |
| 5 | 125.288 | 5.34 | 1.49700 | 81.7 |
| 6 | −296.401 | 0.31 | | |
| 7 | −253.883 | 1.45 | 1.83400 | 37.2 |
| 8 | 84.599 | 0.15 | | |
| 9 | 83.338 | 5.44 | 1.59282 | 68.6 |
| 10 | −1443.043 | (Variable) | | |
| 11 | 631.408 | 2.73 | 1.85478 | 24.8 |
| 12 | −161.518 | 0.15 | | |
| 13 | −509.568 | 1.25 | 1.59282 | 68.6 |
| 14 | 87.535 | (Variable) | | |
| 15 | −221.759 | 1.20 | 1.59282 | 68.6 |
| 16 | 58.637 | 3.29 | 1.66565 | 35.6 |
| 17 | 426.730 | 3.01 | | |
| 18 | −56.885 | 1.00 | 1.49700 | 81.7 |
| 19 | 558.854 | (Variable) | | |
| 20 (SP) | ∞ | (Variable) | | |
| 21 | 47.779 | 7.14 | 1.43387 | 95.1 |
| 22 | −134.953 | 0.15 | | |
| 23 | 66.001 | 4.11 | 1.59282 | 68.6 |
| 24 | 804.355 | 0.15 | | |
| 25 | 54.394 | 6.63 | 1.49700 | 81.7 |
| 26 | −81.105 | 1.40 | 1.74400 | 44.8 |
| 27 | 65.118 | 19.81 | | |
| 28 | −55.737 | 2.26 | 1.74951 | 35.3 |
| 29 | −29.304 | 1.00 | 1.61997 | 63.9 |
| 30 | 37.868 | 3.17 | | |
| 31 | 62.476 | 1.00 | 1.96300 | 24.1 |
| 32 | 38.936 | 3.54 | 1.53775 | 74.7 |
| 33* | −381.530 | 0.15 | | |
| 34 | 46.452 | 3.70 | 1.65160 | 58.5 |
| 35 | −126.812 | (Variable) | | |
| 36 | 477.057 | 1.89 | 1.80810 | 22.8 |
| 37 | −111.706 | 0.85 | 1.88300 | 40.8 |
| 38 | 66.620 | (Variable) | | |
| 39 | 1273.663 | 3.44 | 1.51823 | 58.9 |
| 40 | −64.646 | (Variable) | | |
| 41 | −53.012 | 1.20 | 1.49700 | 81.7 |
| 42 | 71.145 | 10.67 | 1.51633 | 64.1 |
| 43 | −26.451 | 1.20 | 1.49700 | 81.7 |
| 44 | −1149.855 | (Variable) | | |
| Image Plane | ∞ | | | |

ASPHERIC DATA
33rd Surface
K = 0.00000e+00 A 4 = 1.40271e−06 A 6 = −2.47421e−10
A 8 = 1.80038e−11 A10 = −1.20178e−13 A12 = 2.66081e−16

VARIOUS DATA

| | |
|---|---|
| ZOOM RATIO | 4.71 |

| | WIDE | MIDDLE | TELE |
|---|---|---|---|
| Focal Length | 103.01 | 175.25 | 484.99 |
| Fno | 4.63 | 5.65 | 6.49 |
| Half Angle of View (°) | 11.86 | 7.04 | 2.55 |
| Image Height | 21.64 | 21.64 | 21.64 |
| Overall Lens Length | 286.01 | 334.52 | 365.98 |
| BF | 37.99 | 33.33 | 77.03 |
| d4 | 0.90 | 49.91 | 81.86 |
| d10 | 1.00 | 20.06 | 33.56 |
| d14 | 8.95 | 19.86 | 27.35 |
| d19 | 55.19 | 24.71 | 3.24 |
| d20 | 31.10 | 36.32 | −0.25 |
| d35 | 1.50 | 4.94 | 1.49 |
| d38 | 32.63 | 29.19 | 32.64 |
| d40 | 9.14 | 8.59 | 1.46 |
| d44 | 37.99 | 33.33 | 77.03 |

LENS UNIT DATA

| Lens Unit | Starting Surface | Focal Length |
|---|---|---|
| 1 | 1 | 291.18 |
| 2 | 5 | 9682.04 |
| 3 | 11 | −801.59 |
| 4 | 15 | −78.35 |
| 5 | 21 | 63.90 |
| 6 | 36 | −81.97 |
| 7 | 39 | 118.82 |
| 8 | 41 | −127.35 |

NUMERICAL EXAMPLE 6
UNIT: mm
SURFACE DATA

| Surface No. | r | d | nd | νd |
|---|---|---|---|---|
| 1 | 192.186 | 6.38 | 1.49700 | 81.5 |
| 2 | −508.898 | (Variable) | | |
| 3 | 60.808 | 8.13 | 1.43875 | 94.7 |
| 4 | −153.103 | 1.25 | 1.66565 | 35.6 |
| 5 | 136.068 | (Variable) | | |
| 6 | 112.014 | 1.18 | 1.76385 | 48.5 |
| 7 | 40.657 | 4.74 | | |
| 8 | −92.208 | 1.25 | 1.49700 | 81.5 |
| 9 | 50.079 | 2.98 | 1.85478 | 24.8 |
| 10 | 193.931 | (Variable) | | |
| 11 | 33.682 | 7.18 | 1.49700 | 81.5 |
| 12 | −753.639 | 0.15 | | |
| 13 | 45.521 | 4.41 | 1.43875 | 94.7 |
| 14 | 747.222 | 3.44 | | |
| 15 | ∞ | 4.46 | | |
| 16 | −84.823 | 1.15 | 1.75500 | 52.3 |
| 17 | 28.119 | 1.99 | | |
| 18 | 39.496 | 1.10 | 2.00100 | 29.1 |
| 19 | 30.015 | 4.28 | 1.49700 | 81.5 |
| 20 | 592.813 | 0.10 | 1.58946 | 30.6 |
| 21* | 581.298 | 0.15 | | |
| 22 | 45.903 | 3.97 | 1.51742 | 52.4 |
| 23 | −89.697 | (Variable) | | |
| 24 | 269.188 | 3.39 | 1.96300 | 24.1 |
| 25 | −31.630 | 0.90 | 1.77047 | 29.7 |
| 26 | 31.876 | (Variable) | | |
| 27* | 41.373 | 0.10 | 1.58946 | 30.6 |
| 28 | 41.438 | 4.95 | 1.66565 | 35.6 |
| 29 | −35.201 | 1.00 | 1.95906 | 17.5 |
| 30 | −68.199 | (Variable) | | |
| 31 | −566.887 | 1.00 | 1.81600 | 46.6 |
| 32 | 22.138 | 4.61 | 1.61340 | 44.3 |
| 33 | −209.907 | 0.88 | | |
| 34 | −46.521 | 1.00 | 1.49700 | 81.5 |
| 35 | 51.081 | (Variable) | | |
| 36 | −93.210 | 2.70 | 1.85478 | 24.8 |
| 37 | −51.903 | (Variable) | | |
| Image Plane | ∞ | | | |

ASPHERIC DATA
21st Surface
K = 0.00000e+00 A 4 = 3.06078e−06 A 6 = 1.73892e−10
A 8 = 6.89073e−12 A10 = −4.56144e−14 A12 = 1.05385e−16
27th Surface
K = 0.00000e+00 A 4 = 2.47584e−06 A 6 = 5.75349e−09
A 8 = −5.56712e−11 A10 = 4.81095e−13 A12 = −1.44822e−15

VARIOUS DATA

| | |
|---|---|
| ZOOM RATIO | 4.70 |

| | WIDE | MIDDLE | TELE |
|---|---|---|---|
| Focal Length | 103.24 | 201.65 | 484.75 |
| Fno | 4.63 | 5.35 | 6.43 |
| Half Angle of View (°) | 11.84 | 6.12 | 2.56 |
| Image Height | 21.64 | 21.64 | 21.64 |
| Overall Lens Length | 238.68 | 290.83 | 336.09 |
| BF | 46.01 | 46.01 | 46.01 |
| d2 | 0.90 | 53.04 | 98.31 |
| d5 | 0.90 | 14.97 | 46.99 |
| d10 | 71.48 | 40.51 | 0.75 |
| d23 | 13.13 | 10.74 | 1.02 |
| d26 | 4.53 | 6.92 | 16.64 |
| d30 | 7.61 | 9.02 | 0.90 |
| d35 | 15.29 | 30.78 | 46.65 |
| d37 | 46.01 | 46.01 | 46.01 |

LENS UNIT DATA

| Lens Unit | Starting Surface | Focal Length |
|---|---|---|
| 1 | 1 | 281.54 |
| 2 | 3 | 890.89 |
| 3 | 6 | −68.01 |
| 4 | 11 | 62.48 |
| 5 | 24 | −70.05 |
| 6 | 27 | 46.57 |
| 7 | 31 | −34.61 |
| 8 | 36 | 133.01 |

TABLE 1

| | Numerical Example | | | | | |
|---|---|---|---|---|---|---|
| | 1 | 2 | 3 | 4 | 5 | 6 |
| D2w | 17.51 | 15.78 | 24.87 | 21.58 | 22.42 | 23.48 |
| D2t | 116.51 | 178.15 | 178.31 | 220.46 | 103.38 | 166.97 |
| fL1 | 284.69 | 415.08 | 327.63 | 522.91 | 291.18 | 281.54 |
| fL2 | −530.88 | −442.00 | −1181.41 | 9459.33 | 9682.04 | 890.89 |
| TLw | 238.21 | 239.52 | 285.66 | 286.09 | 286.01 | 238.68 |
| ML1 | −99.00 | −162.38 | −104.93 | −199.00 | −79.97 | −97.41 |
| ML2 | 0.00 | 0.00 | 0.00 | −0.12 | 0.99 | 0.00 |
| ML3 | 32.42 | 30.82 | 48.52 | 39.49 | 33.54 | 46.08 |
| Skw | 57.29 | 45.64 | 37.71 | 37.92 | 37.99 | 46.01 |
| MF1 | −18.22 | −9.45 | −19.43 | −14.92 | −8.23 | 21.35 |
| MF2 | 21.60 | 25.95 | 26.02 | 25.97 | 25.91 | 7.92 |
| νdL1Pave. | 81.54 | 94.66 | 81.54 | 67.00 | 88.38 | 81.54 |
| νdL2Pave. | 95.10 | 95.10 | 95.10 | 95.10 | 75.14 | 94.66 |
| νdL2Nave. | 29.74 | 29.74 | 33.27 | 33.27 | 33.27 | 35.64 |
| ndG1 | 1.50 | 1.44 | 1.50 | 1.59 | 1.50 | 1.50 |
| (1) | 6.65 | 11.29 | 7.17 | 10.21 | 4.61 | 7.11 |
| (2) | −0.54 | −0.94 | −0.28 | 0.06 | 0.03 | 0.32 |
| (3) | 0.42 | 0.68 | 0.37 | 0.70 | 0.28 | 0.41 |
| (4) | 0.14 | 0.13 | 0.17 | 0.14 | 0.12 | 0.19 |
| (5) | 0.33 | 0.19 | 0.46 | 0.20 | 0.42 | 0.47 |
| (6) | 0.00 | 0.00 | 0.00 | 0.00 | 0.01 | 0.00 |
| (7) | 0.00 | 0.00 | 0.00 | 0.00 | 0.03 | 0.00 |
| (8) | 0.20 | 0.11 | 0.12 | 0.07 | 0.13 | 0.16 |
| (9) | 0.84 | 0.36 | 0.75 | 0.57 | 0.32 | 2.70 |
| (10) | 81.54 | 94.66 | 81.54 | 67.00 | 88.38 | 81.54 |
| (11) | 95.10 | 95.10 | 95.10 | 95.10 | 75.14 | 94.66 |
| (12) | 29.74 | 29.74 | 33.27 | 33.27 | 33.27 | 35.64 |
| (13) | 1.50 | 1.44 | 1.50 | 1.59 | 1.50 | 1.50 |

### Image Pickup Apparatus

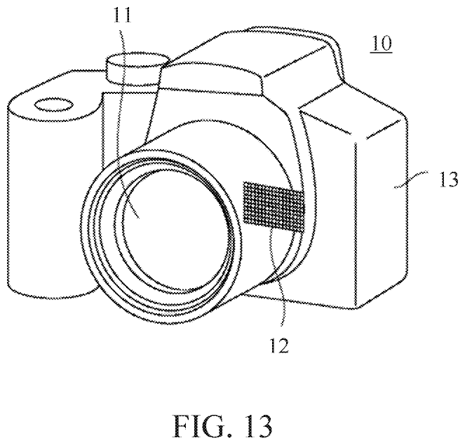

FIG. 13 illustrates an image pickup apparatus (a digital still camera) 10 using the zoom lens L0 according to any one of Examples 1 to 6 as an imaging optical system. The image pickup apparatus 10 includes a camera body 13, a zoom lens 11 (L0) according to any one of Examples 1 to 6, and an image sensor 12 that photoelectrically converts (images a object of) an optical image formed by the zoom lens 11.

Since the image pickup apparatus 10 includes the zoom lens 11 that has a reduced size and high optical performance, a captured image with high image quality may be obtained. Various aberrations such as distortion and chromatic aberration of the captured image obtained by the image sensor 12 may be electrically corrected.

### Imaging System

An imaging system including the zoom lens L0 according to any one of the examples and a control unit that controls the zoom lens L0 may constitute, for example, a surveillance camera system. In this case, the control unit can control the zoom lens L0 so that respective lens units move as described above during zooming, focusing, and image stabilization. The control unit does not necessarily need to be integrated with the zoom lens L0, and the control unit may be separate from the zoom lens L0. For example, a configuration may be adopted in which a control apparatus serving as the control unit disposed at a position distant from a driving unit that drives respective lenses of the zoom lens L0 includes a transmitter that transmits a control signal (command) for controlling the zoom lens L0 to the zoom lens L0. According to such a control unit, the zoom lens L0 may be remotely controlled.

The control unit may include an operation unit such as a controller or buttons for remotely controlling the zoom lens L0, and the zoom lens L0 may be controlled in accordance with an input by a user to the operation unit. For example, an enlargement button and a reduction button may be provided as the operation unit. In this case, a signal may be transmitted from the control unit to the driving unit of the zoom lens L0 so that a magnification of the zoom lens L0 increases when the user presses the enlargement button and decreases when the user presses the reduction button.

The imaging system may further include a display unit such as a liquid crystal panel that displays information on zooming of the zoom lens L0. The information on zooming includes a zoom magnification (zoom state) and a moving amount (movement state) of each lens unit. In this case, the user may remotely control the zoom lens L0 via the operation unit while viewing the information on zooming of the zoom lens L0 displayed on the display unit. A touch panel may be adopted so that the display unit and the operation unit are integrated.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

Each example can provide a zoom lens having a reduced size and weight, and high optical performance over an entire zoom range.

What is claimed is:

1. A zoom lens comprising:
lens units that consist of, in order from an object side to an image side, a first lens unit having positive refractive power, a second lens unit, and a rear group including a plurality of lens units,
wherein each distance between adjacent lens units changes during zooming,
wherein a lens unit disposed closest to an image plane in the zoom lens has negative refractive power,
wherein, during zooming from a wide-angle end to a telephoto end,
a distance between the first lens unit and the second lens unit increases and a distance between the second lens unit and the rear group increases, and
wherein the following inequalities are satisfied:
$$4.4 \leq D 2 t / D 2 w \leq 15.$$
$$- 2.8 \leq fL 1 / fL 2 \leq 3.$$
where D2w is a distance on an optical axis from a surface closest to an object of the zoom lens to a surface closest to the image plane of the second lens unit at the wide-angle end, D2t is a distance on the optical axis from the surface closest to the object to the surface closest to the image plane of the second lens unit at the telephoto end, fL1 is a focal length of the first lens unit, and fL2 is a focal length of the second lens unit.

2. The zoom lens according to claim 1, wherein the rear group includes three or more lens units, and
wherein a distance between adjacent lens units in the rear group changes during zooming.

3. The zoom lens according to claim 1, wherein the following inequality is satisfied:
$$0.15 \leq \vert ML 1 / TLw \vert \leq 0. 90$$
where ML1 is a moving amount of the first lens unit during zooming from the wide-angle end to the telephoto end, and TLw is an overall optical length of the zoom lens at the wide-angle end.

4. The zoom lens according to claim 1, wherein the rear group includes a third lens unit disposed closest to the object, and
wherein the following inequality is satisfied:
$$0.05 \leq \vert ML 3 / TLw \vert \leq 0. 40$$
where ML3 is a moving amount of the third lens unit during zooming from the wide-angle end to the telephoto end, and TLw is an overall optical length of the zoom lens at the wide-angle end.

5. The zoom lens according to claim 1, wherein the rear group includes a third lens unit disposed closest to the object, and
wherein the following inequality is satisfied:
$$0.05 \leq \vert ML 3 / ML 1 \vert \leq 0. 80$$
where ML1 is a moving amount of the first lens unit during zooming from the wide-angle end to the telephoto end, and ML3 is a moving amount of the third lens unit during zooming from the wide-angle end to the telephoto end.

6. The zoom lens according to claim 1, wherein the following inequality is satisfied:
$$\vert ML 2 / ML 1 \vert \leq 0. 20$$
where ML2 is a moving amount of the second lens unit during zooming from the wide-angle end to the telephoto end, and ML1 is a moving amount of the first lens unit during zooming from the wide-angle end to the telephoto end.

7. The zoom lens according to claim 1, wherein the rear group includes a third lens unit disposed closest to the object, and
wherein the following inequality is satisfied:
$$\vert ML 2 / ML 3 \vert \leq 0. 40$$
where ML2 is a moving amount of the second lens unit during zooming from the wide-angle end to the telephoto end, and ML3 is a moving amount of the third lens unit during zooming from the wide-angle end to the telephoto end.

8. The zoom lens according to claim 1, where the following inequality is satisfied:
$$0.03 \leq Skw / fL 1 \leq 0.5$$
where Skw is a back focus of the zoom lens at the wide-angle end.

9. The zoom lens according to claim 1, wherein the rear group includes a first focus lens unit configured to move during focusing and a second focus lens unit that is disposed closer to the image plane than the first focus lens unit and configured to move during focusing, and
wherein the following inequality is satisfied:
$$0. 20 \leq \vert MF 1 / MF 2 \vert \leq 5.$$
where MF1 is a moving amount of the first focus lens unit during focusing from an object at infinity to an object at a close distance at the telephoto end, and MF2 is a moving amount of the second focus lens unit during focusing from the object at infinity to the object at the close distance at the telephoto end.

10. The zoom lens according to claim 1, wherein the first lens unit includes at least one positive lens, and the following inequality is satisfied:
$$60 \leq ν dL 1 Pave . \leq 99$$
where vdL1Pave. is an average value of Abbe numbers based on a d-line of all positive lenses included in the first lens unit.

11. The zoom lens according to claim 1, wherein the second lens unit includes at least one positive lens, and the following inequality is satisfied:
$$60 \leq ν dL 2 Pave . \leq 99$$
where vdL2Pave. is an average value of Abbe numbers based on a d-line of all positive lenses included in the second lens.

12. The zoom lens according to claim 1, wherein the second lens unit includes at least one negative lens, and the following inequality is satisfied:
$$20 \leq ν dL 2 Nave . \leq 45$$
where vdL2Nave. is an average value of Abbe numbers based on a d-line of all negative lenses included in the second lens unit.

13. The zoom lens according to claim 1, wherein the first lens unit includes at least one positive lens, and the following inequality is satisfied:
$$1.4 \leq ndG 1 \leq 1.7$$
where ndG1 is a refractive index at a d-line of a positive lens disposed closest to the object among the at least one positive lens.

14. The zoom lens according to claim 1, wherein the first lens unit consists of two single lenses or fewer.

15. The zoom lens according to claim 1, wherein the second lens unit consists of three lenses or fewer.

16. The zoom lens according to claim 1, wherein the rear group includes a third lens unit disposed closest to the object, and the third lens unit consists of four lenses or fewer.

17. The zoom lens according to claim 9, wherein the first focus lens unit consists of three or fewer lenses.

18. The zoom lens according to claim 9, wherein the second focus lens unit consists of three lenses or fewer.

19. The zoom lens according to claim 1, wherein at least a part of one lens unit included in the rear group is an image stabilizing unit configured to move relative to the optical axis in order to reduce image blur.

20. The zoom lens according to claim 1, wherein the rear group includes a third lens unit disposed closest to the object and configured to move toward the image side during zooming from the wide-angle end to the telephoto end.

21. The zoom lens according to claim 1, wherein the rear group includes a third lens unit disposed closest to the object, and an aperture stop, and
wherein the aperture stop is configured to move independently of the third lens unit during zooming.

22. The zoom lens according to claim 1, wherein the lens units constituting the zoom lens consist of, in order from the object side to the image side, the first lens unit, the second lens unit having negative refractive power, a third lens unit having positive refractive power, a fourth lens unit having negative refractive power, a fifth lens unit having positive refractive power, a sixth lens unit having positive refractive power, and a seventh lens unit having negative refractive power.

23. The zoom lens according to claim 1, wherein the lens units constituting the zoom lens consist of, in order from the object side to the image side, the first lens unit, the second lens unit having negative refractive power, a third lens unit having negative refractive power, a fourth lens unit having negative refractive power, a fifth lens unit having positive refractive power, a sixth lens unit having negative refractive power, a seventh lens unit having positive refractive power, and an eighth lens unit having negative refractive power.

24. The zoom lens according to claim 1, wherein the lens units constituting the zoom lens consist of, in order from the object side to the image side, the first lens unit, the second lens unit having positive refractive power, a third lens unit having positive refractive power, a fourth lens unit having negative refractive power, a fifth lens unit having positive refractive power, a sixth lens unit having negative refractive power, a seventh lens unit having positive refractive power, and an eighth lens unit having negative refractive power.

25. The zoom lens according to claim 1, wherein the lens units constituting the zoom lens consist of, in order from the object side to the image side, the first lens unit, the second lens unit having positive refractive power, a third lens unit having negative refractive power, a fourth lens unit having negative refractive power, a fifth lens unit having positive refractive power, a sixth lens unit having negative refractive power, a seventh lens unit having positive refractive power, and an eighth lens unit having negative refractive power.

26. The zoom lens according to claim 1, wherein the lens units constituting the zoom lens consist of, in order from the object side to the image side, the first lens unit, the second lens unit having positive refractive power, a third lens unit having negative refractive power, a fourth lens unit having positive refractive power, a fifth lens unit having negative refractive power, a sixth lens unit having positive refractive power, a seventh lens unit having negative refractive power, and an eighth lens unit having positive refractive power.

27. An image pickup apparatus comprising:
a zoom lens according to claim 1; and
an image sensor configured to image an object through the zoom lens,
wherein the zoom lens includes:
lens units that consist of, in order from an object side to an image side, a first lens unit having positive refractive power, a second lens unit, and a rear group including a plurality of lens units,
wherein each distance between adjacent lens units changes during zooming,
wherein a lens unit disposed closest to an image plane in the zoom lens has negative refractive power,
wherein, during zooming from a wide-angle end to a telephoto end, a distance between the first lens unit and the second lens unit increases and a distance between the second lens unit and the rear group increases, and
wherein the following inequalities are satisfied:
$$4. 4 \leq D 2 t / D 2 w \leq 15.$$
$$- 2.8 \leq fL 1 / fL 2 \leq 3.$$
where D2w is a distance on an optical axis from a surface closest to the object of the zoom lens to a surface closest to the image plane of the second lens unit at the wide-angle end, D2t is a distance on the optical axis from the surface closest to the object to the surface closest to the image plane of the second lens unit at the telephoto end, fL1 is a focal length of the first lens unit, and fL2 is a focal length of the second lens unit.
